(19) United States
(12) Patent Application Publication
(10) Pub. No.: US 2005/0069645 A1
(43) Pub. Date: Mar. 31, 2005

(54) Method of electrolytically depositing materials in a pattern directed by surfactant distribution

(75) Inventors: Noshir Sheriar Pesika, Baltimore, MD (US); Kathleen Joan Stebe, Baltimore, MD (US); Peter Searson, Baltimore, MD (US)

Correspondence Address: DOCKET ADMINISTRATOR;LOWENSTEIN SANDLER PC, 65 Livingston Avenue, Roseland, NJ, 07068-1791, US

(73) Assignee: Johns Hopkins University

(21) Appl. No.: 10/836,021

(22) Filed: Apr. 29, 2004

Related U.S. Application Data
(60) Provisional application No. 60/467,248, filed on May 1, 2003.
(60) Provisional application No. 60/523,498, filed on Nov. 19, 2003.

(51) Int. Cl. B05D 5/00; C25D 5/02

(52) U.S. Cl. 427/286; 205/136

(57) ABSTRACT

In accordance with the invention, a surface of a substrate is patterned by the steps of providing the substrate, forming a surfactant pattern on the surface and using electroless deposition or electrodeposition to deposit material on the surface in a pattern directed by the surfactant pattern. The material will preferentially deposit either under the surfactant pattern or outside the surfactant pattern depending on the material and the conditions of deposition. The surfactant pattern is conveniently formed by printing on the surface a surfactant that forms a self assembled monolayer (SAM). The method can be adapted to build complex structures in one, two and three dimensions.

### CROSS REFERENCE TO RELATED APPLICATIONS

This application claims the benefit of U.S. Provisional Application Ser. No. 60/467,248 filed on May 1, 2003 by the present inventors and entitled “Patterned Deposition of Materials as Directed by Surfactant Distribution on Electrodes”. It also claims the benefit of identically titled Provisional Application Ser. No. 60/523,498 filed by the present inventors on Nov. 18, 2003. Both provisional applications are incorporated herein by reference.

### GOVERNMENT INTEREST

This invention was made with government support under NASA Contract NGT5-50372. The government has certain rights in the invention

### FIELD OF THE INVENTION

This invention relates to lithography and, in particular, to a method of high resolution lithography using a surfactant pattern to direct the electrolytic deposition of materials on a substrate surface. The process can be used to produce structures patterned in one, two and three dimensions.

### BACKGROUND OF THE INVENTION

Lithographic processes are crucial for the manufacture of many microelectronic, optical and nanoscale devices, including computer chips, data storage devices, flat screen displays and sensors. Lithographic processes are used to create patterned areas on the surface of a substrate which, in turn, can be further processed as by etching, doping, oxidizing, growing or other processing to form the features of a desired component, circuit or other device.

The competitive pressure to increase the functionality of such devices has required smaller and smaller patterns. As a consequence, manufacturers are pressing the limits of conventional optical and electron beam lithography. Optical lithography forms a pattern by exposing a photoresist to light through an exposure mask. As is well known, optical lithography is limited by the wavelength of the exposure light. Shorter wavelength light, now in the ultraviolet range, is being used to expose smaller patterns, but the shorter the wavelength, the more complex and expensive the equipment required to generate the light and pattern the substrate.

Electron beam lithography (e-beam lithography) forms a pattern on a resist-covered substrate by projecting an electron beam line-by-line onto the resist to form the pattern. However e-beam lithography is limited in resolution by the need for special stencil masks and, because of its line-by-line exposure, is too limited in speed for satisfactory manufacturing. Moreover both optical and electron beam lithography typically use polymer resists which require time consuming steps to develop and remove.

Accordingly there is a need for simpler, faster and less expensive processes for high resolution lithography.

### SUMMARY OF THE INVENTION

In accordance with the invention, a surface of a substrate is patterned by the steps of providing the substrate, forming a surfactant pattern on the surface and using electroless deposition or electrodeposition to deposit material on the surface in a pattern directed by the surfactant pattern. The material will preferentially deposit either under the surfactant pattern in the pattern of the surfactant or outside the surfactant pattern in the complement of the surfactant pattern depending on the material and the conditions of deposition. The surfactant pattern is conveniently formed by printing on the surface a surfactant that forms a self assembled monolayer (SAM). The method can be adapted to build complex structures in one, two and three dimensions.

### BRIEF DESCRIPTION OF THE DRAWINGS

The nature, advantages and various additional features of the invention will appear more fully upon consideration of the illustrative embodiments of the invention described in detail in connection with the accompanying drawings. In the drawings:

FIG. 1 is a schematic block diagram showing the steps in patterning a surface of a substrate in accordance with the invention;

FIGS. 2A, 2B and 2C illustrate steps of an advantageous method of forming a pattern of surfactant on a substrate;

FIGS. 3A, 3B show apparatus for electrodeposition and for electroless deposition respectively;

FIG. 4 schematically illustrates a stamp for forming a surfactant pattern on a substrate;

FIG. 5 is an AFM image of a pattern of electrodeposited material;

FIG. 6 is an AFM image of a pattern of electrodeposited material;

FIGS. 7A, 7B and 7C are a series of AFM images of material deposited at various deposition potentials.

FIG. 8 is an AFM image of nanoscale-width deposited stripes;

FIG. 9 illustrates adaptation of the FIG. 1 process to grow a second material between stripes of a first material;

FIGS. 10A and 10B show a multicomponent structure formed by the process of FIG. 1;

FIG. 11 illustrates adaptation of the FIG. 1 process to form a composite 3D structure;

FIGS. 12A and 12B are AFM images of a composite 3D structure made by the FIG. 1 process; and

FIG. 13 is an AFM image of a grid pattern of silver produced by electroless deposition on a silver substrate patterned with an octanethiol SAM.

It is to be understood that the drawings are for illustrating the concepts of the invention and, except for the micrographs, are not to scale.

### DETAILED DESCRIPTION

A. The Basic Process

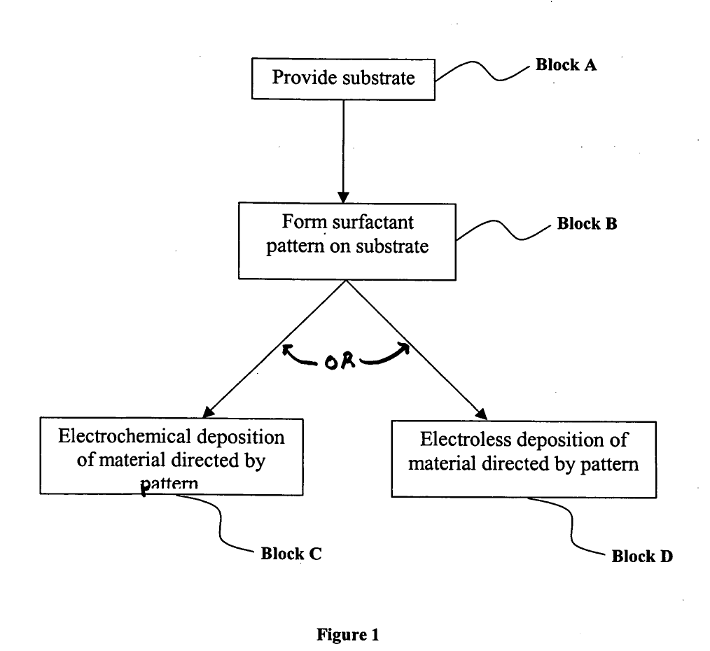

Referring to the drawings, FIG. 1 is a block diagram showing the steps involved in forming a pattern of material on the surface of a substrate. The first step, shown in block A, is to provide a substrate having the surface to be patterned. For electrodeposition, the substrate advantageously comprises a conductive or semiconductor material such as a surface layer of metal. The surface can be an insulator or metal if electroless deposition is used.

The next step, Block B, is to form a surfactant pattern on the surface of the substrate. The pattern is advantageously formed by printing with a stamp a thin surfactant layer that forms a self-assembled monolayer or SAM on the surface. The stamp (referred to as a PDMS stamp) preferably has microscale or nanoscale pattern features. Exemplary surfactants include thiols for gold and silver and isocyanides for platinum and palladium. The stamp can be conveniently fabricated using techniques well known in the art. An alternative approach to forming the surfactant pattern is to apply a continuous film of surfactant on the surface and to remove selected portions as by masked UV exposure or with an atomic force microscope tip.

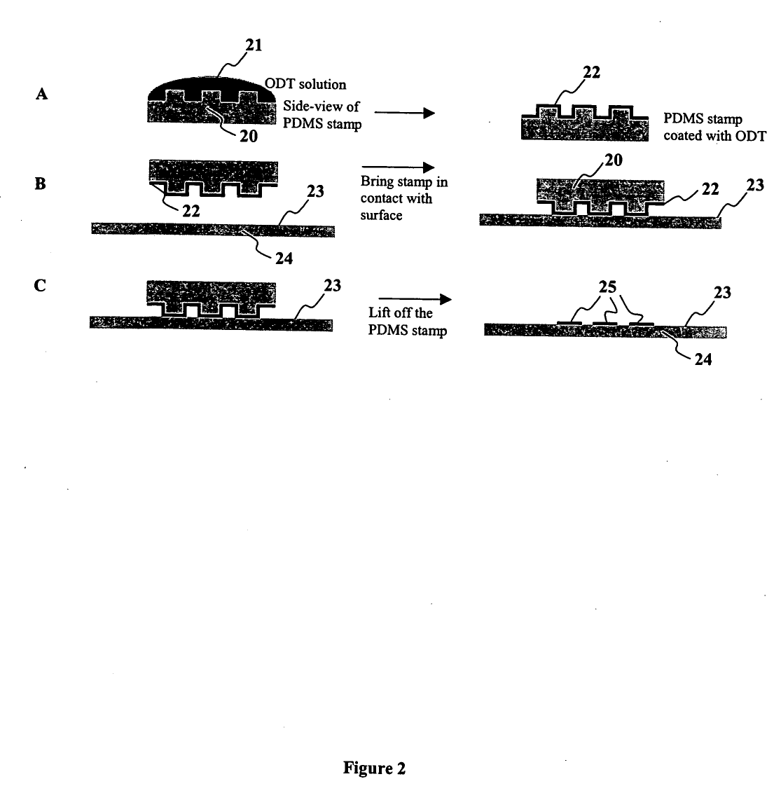

FIGS. 2A through 2C depict steps of an advantageous method of forming the pattern of surfactant on the substrate. As shown in FIG. 2A, a patterned stamp 20 is provided and coated with sufficient surfactant solution 21 to cover that patterned surface. The surfactant is dried to a thin coating 22. The next step (FIG. 2B) is to bring the stamp with surfactant coating 22 into contact with the surface 23 of the substrate 24. As shown in FIG. 2C, the stamp is then lifted off the surface 23 leaving surfactant pattern 25 on the surface. The substrate surface is preferably planar, but can be curved if flexible stamping is used.

Referring back to FIG. 1, the third step shown in Block C is to electrodeposit material in a pattern directed by the surfactant pattern. The material can be preferentially deposited underlying the surfactant in the form of the surfactant pattern or it can be preferentially deposited outside the surfactant pattern, leaving the pattern substantially free of the material. Which of these processes occurs, corresponding to negative and positive resist processes, depends on the deposition conditions.

We have demonstrated that silver can be deposited onto a gold or silver substrate patterned with octadecanethiol in either positive or negative resist mode depending on the deposition potential. Positive resist mode deposition corresponds to deposition in the regions where there is no surfactant. Negative resist mode deposition occurs where the deposition is in the regions where there is surfactant. The ability to operate in both positive and negative resist mode provides many attractive possibilities in depositing complex structures in three dimensions with different materials.

As an alternative to the electrodeposition of Block C, the material can be deposited in a pattern directed by the surfactant pattern using electroless deposition (Block D).

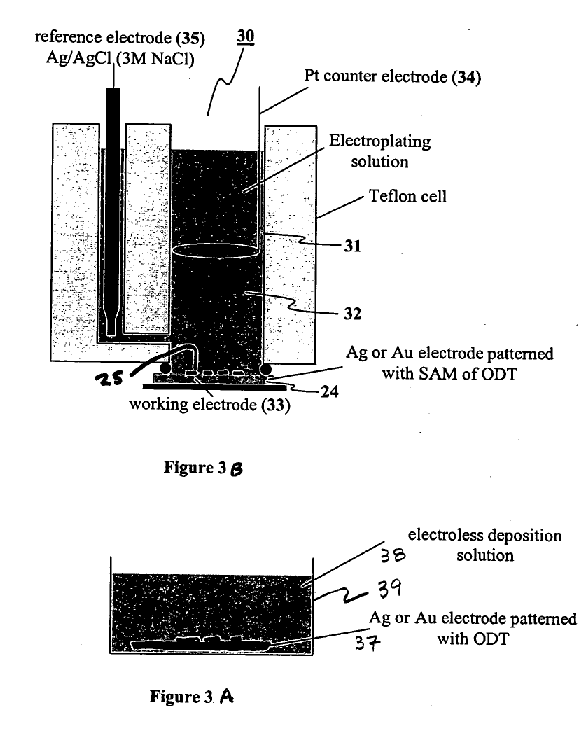

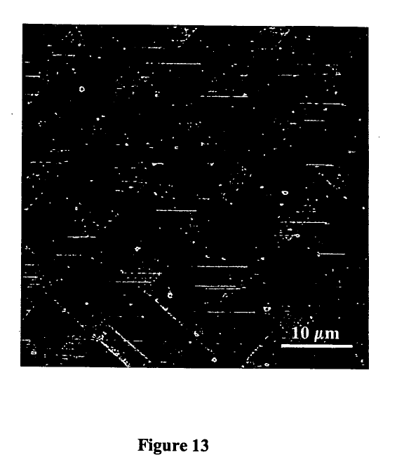

FIG. 3A shows apparatus 36 for electroless deposition to produce a patterned material on a substrate 37. The substrate 37, which can be an insulator, is patterned with surfactant (ODT). It is disposed within an electroless deposition solution 38 within a container 39. A typical electroless bath for depositing silver is a solution containing 450 g/L of silver nitrate, 444 g/L of Rochelle salt, 64 mL/L saturated ammonia solution, and 31 g/L of Epsom salt. FIG. 13 is an AFM plan view image of a silver grid deposited onto an ODT patterned silver substrate by electroless deposition.

FIG. 3B is a schematic illustration of apparatus 30 for electrodeposition of a material onto the surface 23 of a substrate 24. In essence, the apparatus 30 comprises a container 31 enclosing an electrolytic bath 32. The surface 23 with surfactant pattern 25 is disposed in physical contact with the bath 32 and in electrical contact with a working electrode 33. The apparatus further comprises a counter electrode 34 to provide deposition current and a reference electrode 35 for measurement and control. A voltage source (not shown) drives deposition current between electrodes 33 and 34 to effect deposition.

The invention may now be more clearly understood by consideration of the following specific examples.

### EXAMPLE 1

A substrate was prepared comprising a silicon wafer supporting a 100 nm gold film coated on a sublayer of chromium. The 1 inch square substrate was cleaned by rinsing with ethanol and blow drying with pure nitrogen gas.

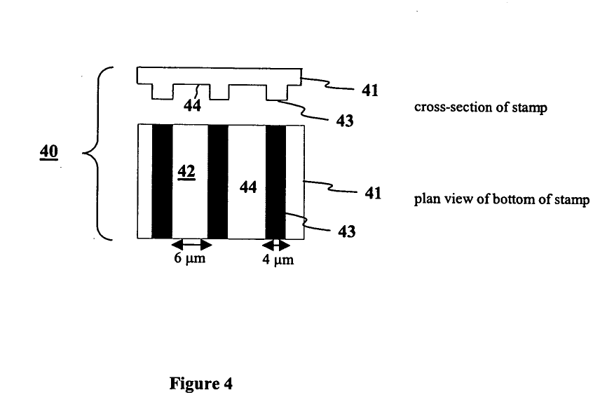

A pattern of surfactant was formed on the gold surface by the printing technique of FIG. 2. A PDMS stamp was made by the procedure described in A. Kumar et al., “Patterning Self-Assembled Monolayers: Applications in Materials Science”, Langmuir (1994), 10, 1498-1511. FIG. 4 is a schematic illustration of the PDMS stamp 40 comprising a body 41 having a patterned surface 42 composed of 3-4 micrometer projecting regions 43 separated by 6-7 micrometer recessed regions 44.

The PDMS stamp was oriented so that the patterned features were on top. The patterned face of the stamp was then coated with a 1-10 mM solution of octadecanethiol (ODT) dissolved in ethanol. After 1 min. the stamp was blow dried with nitrogen gas. The stamp was then placed with the features face-down onto the gold surface, and sufficient pressure was applied to provide complete contact of the patterned stamp surface to the gold surface. After 15 sec, the stamp was lifted off and the gold surface was rinsed with ethanol and blow dried with nitrogen gas. This patterning left a pattern of hydrophobic regions produced by a SAM of the ODT and surrounding hydrophilic regions of bare gold.

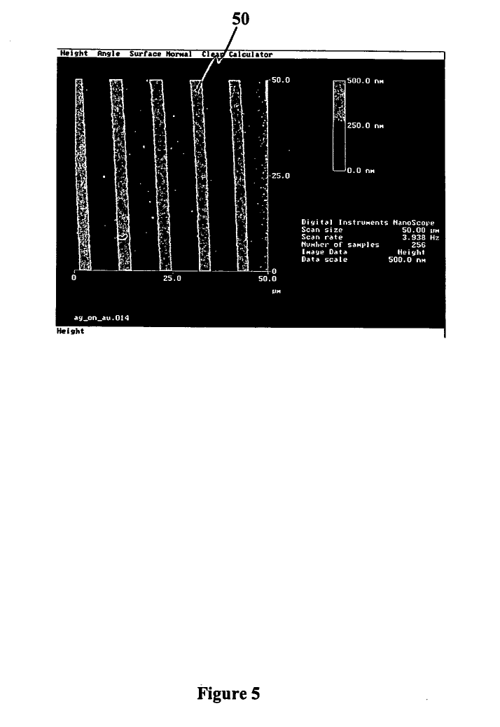

Material was then electrodeposited on the gold surface in a pattern directed by the surfactant pattern. Specifically, an electroplating cell similar to that of FIG. 3 was set up with a silver plating bath composed of an aqueous solution of 20 mM KAg (CN)₂, 0.25 M NaCO₃ buffered to pH 13 with NaOH. The gold surface and the counter electrode were then connected to a potentiostat system using a potential of −0.7 volts as compared with an Ag/AgCl reference electrode to deposit silver on the substrate surface. After deposition of the desired thickness, the set up was disassembled and the substrate was rinsed with distilled water. The silver deposited underneath the SAM surfactant in the same pattern as the printed surfactant pattern. FIG. 5 is an atomic force microscopy (AFM) image of the striped pattern of high silver regions 50.

### EXAMPLE 2

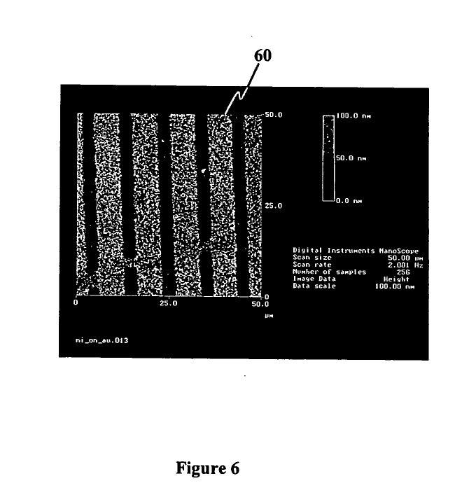

Example 2 used the same set up as Example 1 except that a bath for depositing nickel was used. Specifically the bath was a solution of 20 gL⁻¹ NiCl₂.6H₂O, 500 g L⁻¹ Ni(H₂NSO₃)₂.4H₂O and 20 g L⁻¹H₃BO₃, buffered to pH 3.4. FIG. 6 is an AFM image of the high nickel regions. The nickel 60 deposited on the areas not covered by the printed surfactant.

### EXAMPLE 3

The ODT SAM on a gold or silver substrate can be tuned to act as either a positive or negative resist for the deposition of Ag. At potentials more positive than −0.45 volts as compared with an Ag/AgCl (3M NaCl) reference electrode, the ODT SAM is intact and acts like a positive resist preventing the deposition of Ag the ODT SAM is present. In this case, deposition occurs only on the bare substrate surface. This process (positive resist mode) works for many other metals (e.g. Cu, Ni, Pt) but the potential range and lower limit are different for different metals.

### EXAMPLE 4

By tuning the deposition potential to more potentials more negative than −0.6 volts as compared with an Ag/AgCl (3M NaCl) reference electrode Ag will deposit underneath the patterned surfactant

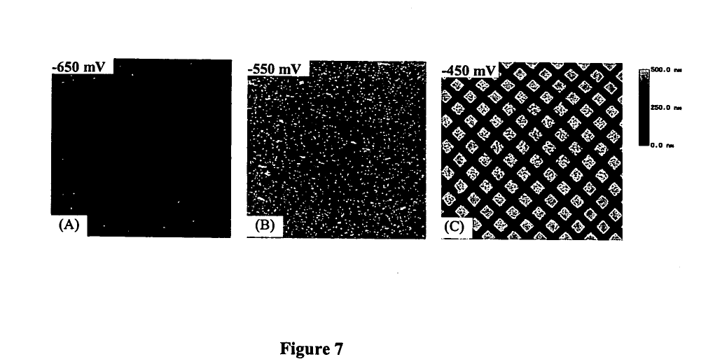

FIGS. 7A, 7B and 7C are a series of AFM topographic images showing how it is possible to tune the ODT SAM from acting as a positive resist to silver to being a negative resist. In FIG. 7A at a deposition potential of −0.65 volts as compared with an Ag/AgCl (3M NaCl) reference electrode the ODT SAM behaves as negative resist. In FIG. 7C at −0.45 volts as compared with an Ag/AgCl (3M NaCl) reference electrode the ODT SAM behaves as a positive resist.

### EXAMPLE 5

Similar tuning by deposition potential has been demonstrated for the deposition of Ag on a gold patterned gold electrode.

### EXAMPLE 6

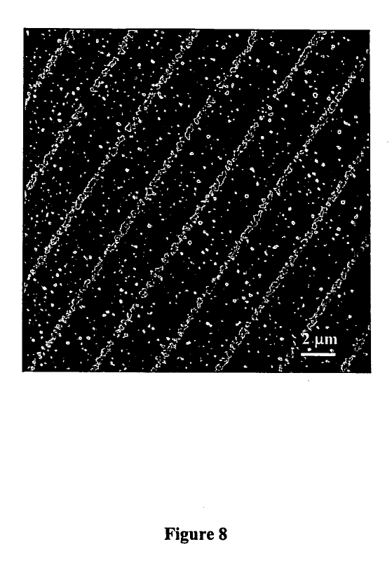

By optimizing the deposition and distribution of the surfactant on the surface of the substrate and the deposition conditions, features of about 400 nm wide (silver stripes) were deposited on a SAM patterned gold surface. FIG. 8 is an AFM image showing the topography of the stripes.

B. Fabrication of Two Dimensional Patterns

While one exemplary application of the FIG. 1 process is in the fabrication of a simple linear array grating, more complex two dimensionally varying patterns can be fabricated. For example, complex stamp patterns with two-dimensionally varying patterns can be fabricated by e-beam lithography and used to print patterns of surfactant prior to electrodeposition or electroless deposition of positive or negative patterns.

Another approach that can be used with even very simple stamp patterns is to apply plural successive stampings with rotated or different stamp patterns. For example, if the stamp of FIG. 4 is axially rotated by 90° and applied a second time before growth, then a two dimensional grid of lines can be grown.

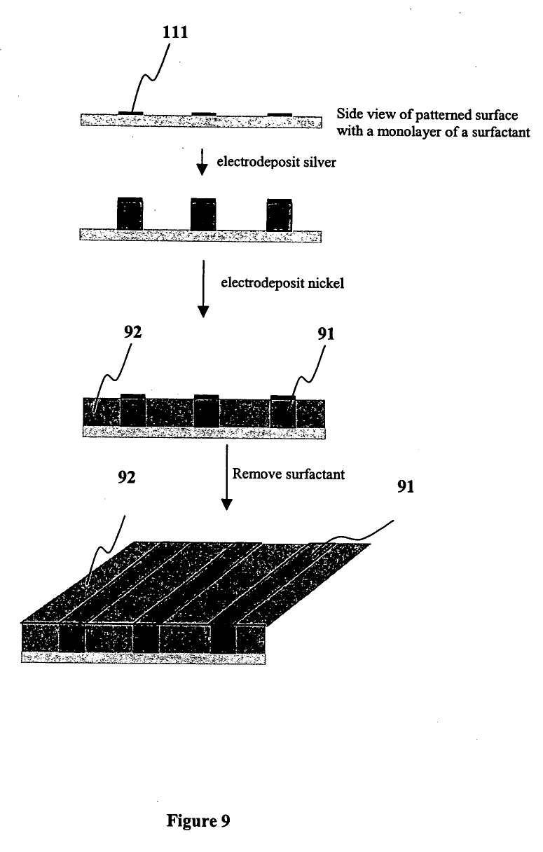

Yet another approach is to take advantage of the fact that a surfactant may act as a positive resist for one material and a negative resist for another. FIG. 9 illustrates a variation of the process wherein a substrate having a SAM pattern serves like a negative resist for the electrolytic growth of a silver pattern 91 and a positive resist for the electrolytic growth of nickel 92, filling the spaces between the silver lines.

### EXAMPLE 7

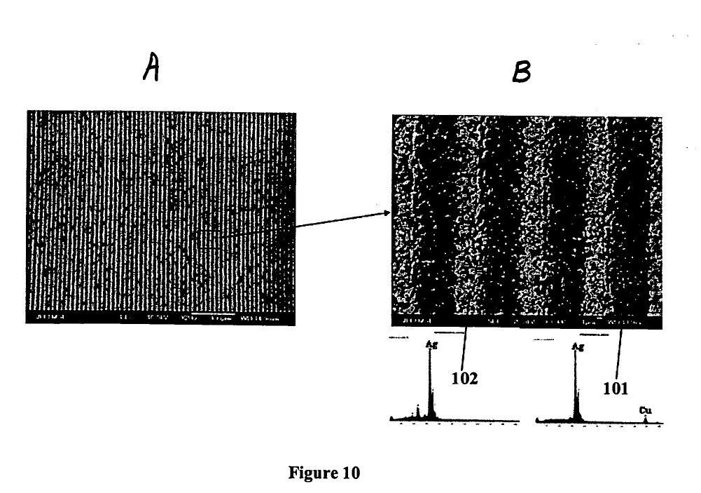

The capability of tuning the resist from being a positive resist to being a negative resist has been exploited to create multi-component structures. A multicomponent structure comprising alternating Ag and Cu stripes was created by first using the ODT SAM pattern as a positive resist for the deposition copper followed by the deposition of silver in the negative resist mode. FIGS. 10A and 10B depict the resulting structure 100 in two different levels of magnification, showing the Cu stripes 101 and Ag stripes 102.

C. Fabrication of Three Dimensional Structures

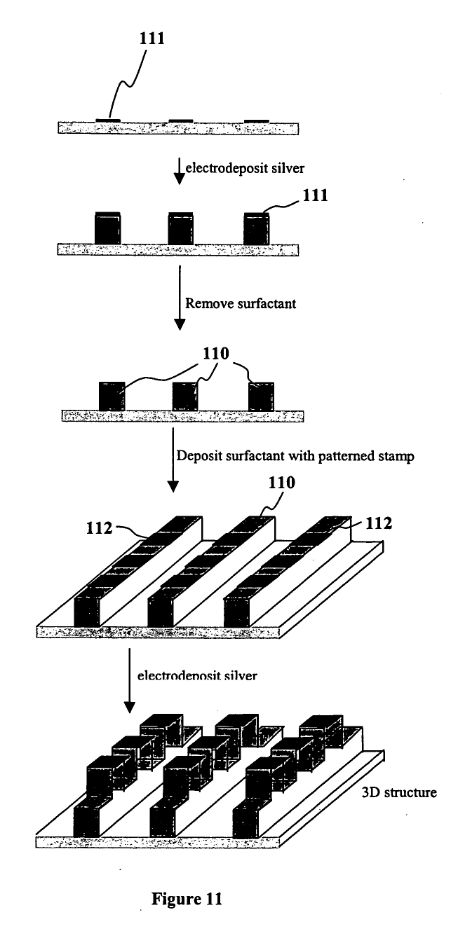

Even more complex three-dimensional structures can be fabricated by applying the process of FIG. 1 multiple times to produce a composite 3D structure. FIG. 11 illustrates a process for making a three-dimensionally varying structure by multiple applications of the FIG. 1 process. The first FIG. 1 process grows a first pattern 110 on the substrate. The surfactant 111 is removed as by exposure to UV light or by the application of a large negative potential (e.g. −1V) to the substrate. Then a second SAMs pattern is printed on the grown pattern 110 to control a second growth step of a pattern corresponding to the intersection of the second SAMs pattern 112 and the high regions of the first pattern 110. This is essentially two successive FIG. 1 processes.

### EXAMPLE 8

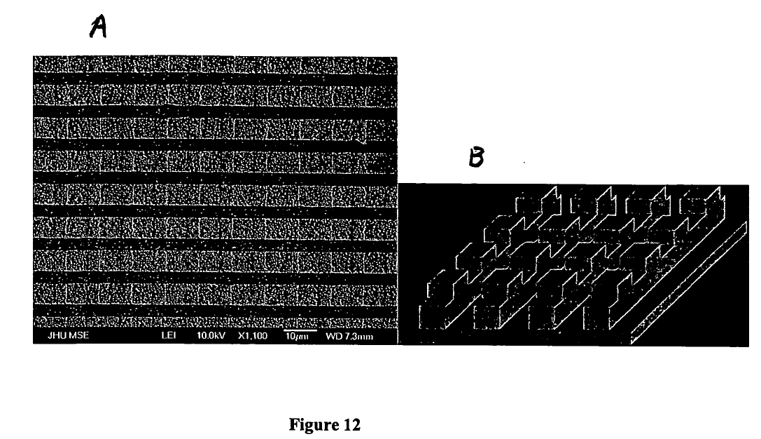

Silver was deposited on a silver substrate in a two step process. In the first step, silver was deposited using a SAM pattern in the positive resist mode to create rows of Ag. In the second step, the same sample was stamped at 90 degrees rotation to create a segmented layer of ODT on the first layer of Ag stripes but perpendicular thereto. The deposition step resulted in pillars of Ag deposited only on the base Ag surface of the first layer of silver stripes. FIG. 12A is an AFM image of the resulting structure. FIG. 12B is a schematic drawing showing the stripes and pillars of the structure.

It can now be seen that we have developed a technique that involves the patterning of a surface with a surfactant and then using electrodeposition or electroless deposition, depositing a pattern of material that is directed by the surfactant. For electrodeposition, at certain potentials, the deposition occurs in the regions where no surfactant is adsorbed (we call this positive resist mode by analogy to photolithography). At other potentials, deposition occurs underneath the surfactant (we call this a negative resist mode).

There are three important components: the substrate, the surfactant, and the depositing material. The surfactant couples to the surface, as by forming a monolayer on the surface (e.g. a self-assembled monolayer). In positive resist mode using electrodeposition, a wide range of materials can be deposited, including elemental metals, alloys, electronically conducting polymers, and some metal oxides and semiconductors including magnetic materials which are of interest in magnetic recording. Electroless deposition can be performed in positive resist mode. The potential advantage here is that it can be done on an insulator. We have demonstrated electroless deposition on a silver substrate. The ability to pattern an insulating surface and to deposit patterned structures thereon can be technologically important.

This process is not limited to deposition on a flat substrate. Since micro-contact printing (stamping) uses a flexible stamp, it can be applied to curved surfaces.

It is understood that the above-described embodiments are illustrative of only a few of the many possible specific embodiments, which can represent applications of the invention. Numerous and varied other arrangements can be made by those skilled in the art without departing from the spirit and scope of the invention.

1. A method of electrolytically depositing materials on a substrate surface in a pattern comprising the steps of:
providing the substrate;
forming a surfactant pattern on the surface;
depositing material on the surface by electrodeposition or electroless deposition, the material deposited in a pattern corresponding to the surfactant pattern or its complement.

2. The method of claim 1 wherein the substrate comprises a conductive, semiconductive, or insulating material.

3. The method of claim 1 wherein the substrate surface is substantially planar.

4. The method of claim 1 wherein the substrate surface is curved.

5. The method of claim 1 wherein forming the surfactant pattern comprises forming a self-assembled monolayer of surfactant.

6. The method of claim 1 wherein forming the surfactant pattern comprises contacting the surface with a surfactant-bearing stamp configured to print the pattern on the surface.

7. The method of claim 1 wherein forming the surfactant pattern comprises covering at least a portion of the surface with a continuous coating of surfactant and removing one or more portions of the continuous coating to form the pattern.

8. The method of claim 7 wherein the removing is by UV light exposure.

9. The method of claim 7 wherein the removing is by a scanning probe.

10. The method of claim 1 wherein the material is deposited on the surface in a pattern corresponding to the surfactant pattern.

11. The method of claim 1 wherein the substrate comprises an insulating surface and the material is deposited by electroless deposition.

12. The method of claim 6 wherein forming the surfactant pattern comprises contacting the surface a plurality of times with at least one surfactant bearing stamp.

13. The method of claim 1 further comprising at least one additional deposition in accordance with claim 1.

14. The method of claim 13 wherein one deposition is in the pattern of the surfactant and the other deposition is in the form of the complement of the surfactant pattern.

15. The method of claim 13 wherein the material of the additional deposition is different from the material of the first deposition.

16. The method of claim 1 wherein the depositing of material comprises selecting a deposition potential to determine whether the material is deposited in a pattern corresponding to the surfactant pattern or in a pattern corresponding to the complement of the surfactant pattern.
